(19) United States
(12) Patent Application Publication
(10) Pub. No.: US 2009/0106522 A1
(43) Pub. Date: Apr. 23, 2009

(54) ELECTRONIC SYSTEM WITH DYNAMIC SELECTION OF MULTIPLE COMPUTING DEVICE

(75) Inventor: Yosuke Muraki, Campbell, CA (US)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 11/874,812

(22) Filed: Oct. 18, 2007

(51) Int. Cl. G06F 12/08

(52) U.S. Cl. 711/202; 711/E12.023

(57) ABSTRACT

An electronic system is provided including powering a computing integrated circuit device having a first processor device and a second processor device; generating an address transform for the first processor device and the second processor device; operating a software code having a first processor address for the first processor device and a second processor address for the second processor device with the software code provides a display or actuates a mechanic device; mapping the first processor address with the address transform to the second processor address; and reconfiguring the address transform.

### TECHNICAL FIELD

The present invention relates generally to electronic systems and more particularly to electronic systems having multiple computing devices.

### BACKGROUND ART

Modern consumer electronics, such as game consoles, notebook computers, smart phones, personal digital assistants, and location based services devices, as well as enterprise class electronics, such as servers, storage arrays, and routers, are packing more integrated circuits into an ever-shrinking physical space with expectations for decreasing cost and increasing performance. Contemporary electronics expose integrated circuits to more demanding and sometimes new environmental conditions, such as cold, heat, and humidity. Higher performance, more functions, lower power usage, and longer usage off battery power are yet other expectations upon contemporary electronics.

As more functions are packed into integrated circuits and more integrated circuits into a package, more heat is generated degrading the performance, the reliability, and the lifetime of the integrated circuits as well as the overall system. Numerous technologies have been developed to meet these new requirements. Some of the research and development strategies focus on the integrated circuit technologies and associated integrated circuit packaging. Other focus on other forms of thermal management solutions, such as heat sinks/slug, heat spreaders, or localized fans directly over the integrated circuit. Yet other solutions may use a combination of solutions.

As a more specific example, recent industrial nanoscale research and development has shown promise for reducing the size of memory and logic circuits in information technology applications. In particular, the multi-core CPU era has arrived. As transistor density increases, the number of transistors comprising a single computer core will not change significantly, but the number of cores packaged on the die may grow exponentially.

As different cores in a multi-core electronic system may be utilized differently, the individual wear or degradation may also be different potentially affecting the performance or reliability of that particular core and subsequently the entire electronic system. For example, one critical problem facing general purpose computer design is heat generated from each core that may affect the reliability and performance of the core. Auto-vectorization of software programs helps averaging the utilization dynamically, but the same group of processors is still used after system power reset. This does not help averaging the total usage if there are light-loaded or idle processors apart from the always-busy processors.

Thus, a need still remains for an electronic system with dynamically improving the performance, lowering manufacturing cost, improving yield, and improving reliability for the electronic systems. In view of the ever-increasing need to save costs and improve efficiencies, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides an electronic system including powering a computing integrated circuit device having a first processor device and a second processor device; generating an address transform for the first processor device and the second processor device; operating a software code having a first processor address for the first processor device and a second processor address for the second processor device with the software code provides a display or actuates a mechanic device; mapping the first processor address with the address transform to the second processor address; and reconfiguring the address transform.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIGS. 1A, 1B, and 1C are schematic views of electronics systems as application examples with embodiments of the present invention;

FIG. 2 is an isometric view of an electronic assembly system in an embodiment of the present invention;

FIG. 3 is a functional block diagram view of a portion of the electronic assembly system of FIG. 2;

FIG. 4 is a graphical view of an address mapping in the electronic assembly system of FIG. 2;

FIG. 5 is a flow chart of a selection process of the electronic assembly system of FIG. 2; and

FIG. 6 is a flow chart of an electronic system for operation of the electronic system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Generally, the invention can be operated in any orientation. In addition, where multiple embodiments are disclosed and described having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the integrated circuit, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

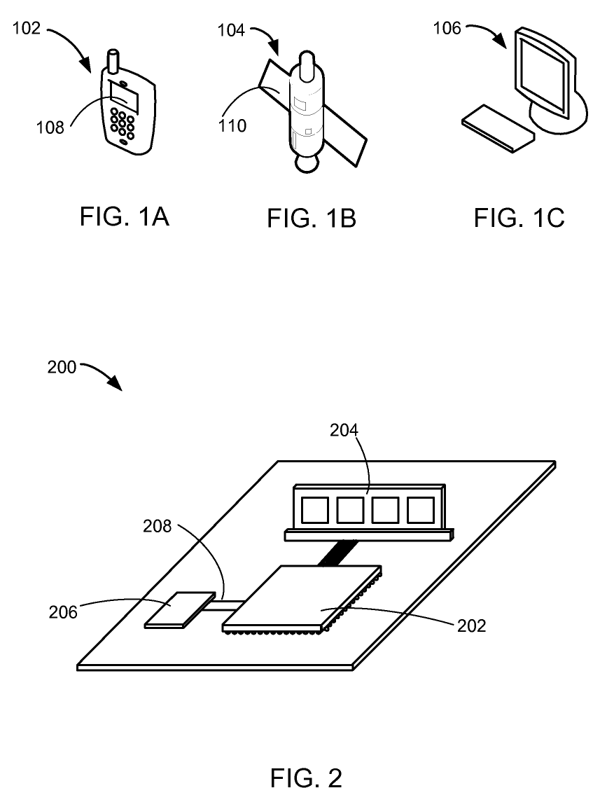

Referring now to FIGS. 1A, 1B, and 1C, therein are shown schematic views of electronics systems as application examples with embodiments of the present invention. A smart phone 102, a satellite 104, and a computing system 106 are examples of the electronic systems using the present invention.

The electronic systems may be any system that performs any function for the creation, transportation, storage, and consumption of information. For example, the smart phone 102 may create information by transmitting voice to the satellite 104. The satellite 104 is used to transport the information to the computing system 106. The computing system 106 may be used to store the information. The smart phone 102 may also consume information sent from the satellite 104. The smart phone 102 provides a display 108 as part of the interface. The satellite 106 has mechanical device 110, such as the solar panels.

The electronic systems, such as the smart phone 102, the satellite 104, and the computing system 106, include a one or more of the electronic subsystem (not shown), such as a printed circuit board having the present invention or an electronic assembly having the present invention. The electronic systems may also be implemented as an adapter card.

Referring now to FIG. 2, therein is shown an isometric view of an electronic assembly system 200 in an embodiment of the present invention. The electronic assembly system 200 may be included in the electronic systems as exemplified by the smart phone 102 of FIG. 1, the satellite 104 of FIG. 1, and the computing system 106 of FIG. 1.

The electronic assembly system 200 includes a computing integrated circuit device 202 connected to a memory device 204 and a mapping device 206. The computing integrated circuit device 202 may operate on the data and software code from the memory device 204. Operation of the electronic assembly system 200 may provide image to the display 108 of FIG. 1A or move the mechanic device 110 of FIG. 1B. Results from the operation of the computing integrated circuit device 202 may be stored back to the memory device 204 for future use or for data retention purposes. Mapping outputs 208 from the mapping device 206 may interact with the data and the software code within the computing integrated circuit device 202.

For illustrative purposes, the electronic assembly system 200 shows the computing integrated circuit device 202, the memory device 204, and the mapping device 206 as discrete devices, although it is understood that the device partition in the electronic assembly system 200 may be different. For example, the mapping device 206 in part or as a whole may be included in the computing integrated circuit device 202. Also as an example, the memory device 204 may include volatile memory, non-volatile memory, or a combination thereof. Specific examples of volatile memory include static random memory access (SRAM) devices or dynamic random memory access (DRAM) devices. Specific examples of the non-volatile memory include read only memory (ROM), electrical programmable read only memory (EPROM), Flash memory, and rotating memory, such as hard disk drives. For illustrative purposes, the memory device 204 is shown with a memory hierarchy having a single level, although it is understood that the memory device 204 may represent a system memory hierarchy having multiple levels.

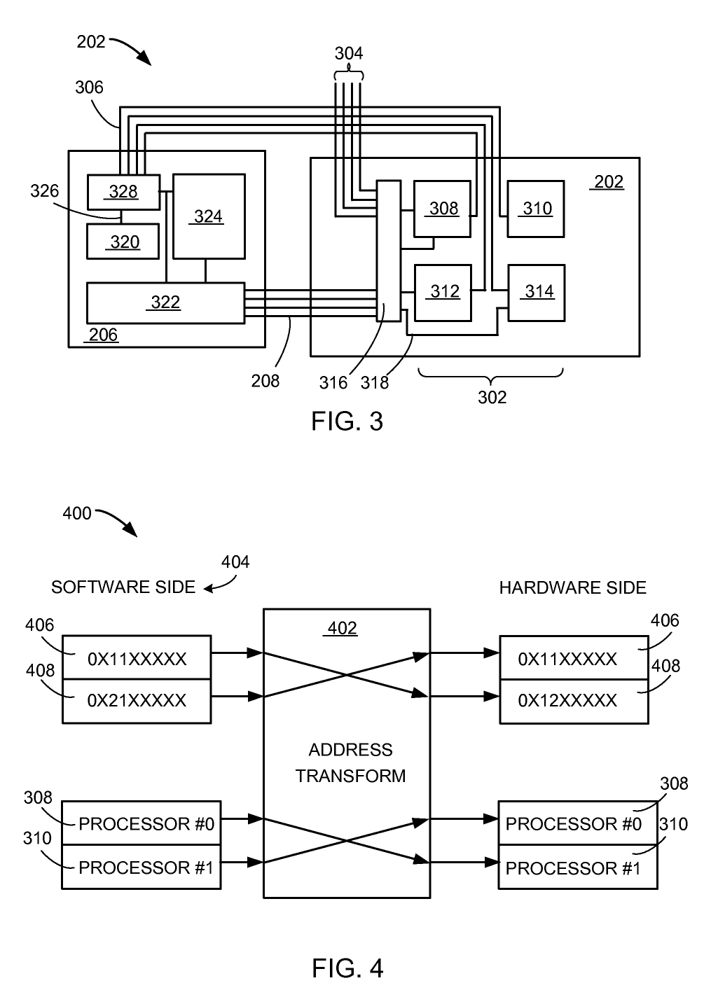

Referring now to FIG. 3, therein is a functional block diagram view of a portion of the electronic assembly system 200 of FIG. 2. The functional block diagram depicts the computing integrated circuit device 202 having processing devices 302. The computing integrated circuit device 202 may be implement in a number of ways. For example, the processing devices 302 may be discrete integrated circuits and the computing integrated circuit device 202 may be a multi-chip module. As another example, the computing integrated circuit device 202 may be a single integrated circuit with the processing devices 302 as processor cores included in the computing integrated circuit device 202.

The computing integrated circuit device 202 may receive data or software code from a memory interface 304 from the memory device 204 of FIG. 2. The computing integrated circuit device 202 may also receive the mapping outputs 208 from the mapping device 206. The mapping device 206 in turn may receive compute inputs 306 from the computing integrated circuit device 202, wherein the compute inputs 306 may be from the processing devices 302 and may include address, data, status, or commands.

The processing devices 302 include a first processor device 308, a second processor device 310, a third processor device 312, and a fourth processor device 314. The processing devices 302 may or may not be substantially the same to each other. The computing integrated circuit device 202 also includes a selection circuit 316 generating selected outputs 318 from the information from the memory interface 304 based on the mapping outputs 208. The selected outputs 318 may route the information from the memory interface 304 to the first processor device 308, the second processor device 310, the third processor device 312, the fourth processor device 314, ore a combination thereof. The selected outputs 318 may also include processor selection to the first processor device 308, the second processor device 310, the third processor device 312, and the fourth processor device 314.

The mapping device 206 may include a power on reset circuit 320, a control circuit 322, a storage circuit 324, and a mapping circuit 326. The power on reset circuit 320 is optional to the mapping device 206 and may be included in other portions of the electronic assembly system 200 of FIG. 2. The power on reset circuit 320 generates a reset signal 328 in the mapping device 206 and potentially to other parts of the electronic assembly system 200.

As an example, the reset signal 328 is shown between the power on reset circuit 320 and the control circuit 322 in the mapping device 206. The control circuit 322 may be implemented in a number of different ways. For example, the control circuit 322 may be implemented with a finite state machine using digital logic or with a general purpose computing core.

The control circuit 322 may also interface with the storage circuit 324 and the mapping circuit 326. The storage circuit 324 may provide volatile storage, non-volatile storage, or a combination thereof for the control circuit 322 to save intermediate data as well as a resultant data. The control circuit 322 may operate on the information from the storage circuit 324. The control circuit 322 may also operate with the information over the compute inputs 306 from the computing integrated circuit device 202.

The control circuit 322 may save the results from its operations into the mapping circuit 326. The mapping circuit 326 may generate the mapping outputs 208 to the computing integrated circuit device 202. For illustrative purposes, the mapping device 206 is shown with the control circuit 322 and the mapping circuit 326 as discrete circuits, although it is understood that the mapping device 206 may include the functions of the control circuit 322 and the mapping circuit 326 with a different functional partition. For example, the control circuit 322 and the mapping circuit 326 may be collapsed into a single control mapping circuit (not shown) including both the control functions and the mapping functions. As a more specific example, the control circuit 322 and the mapping circuit 326 may be from a pseudo number random generator with linear feedback shift registers for generating random or pseudo random numbers.

Referring now to FIG. 4, therein is shown a graphical view of an address mapping 400 in the electronic assembly system 200 of FIG. 2. The mapping device 206 and the computing integrated circuit device 202 may prevent bias usage of a portion of the processing devices 302 by dynamically changing or randomizing the system address map between power cycling the electronic assembly system 200 of FIG. 2. The dynamic or randomized address map may prevent inadvertent heavily loading a portion of the processing devices 302 potentially leading to over usage and exhaustion of the heavily used portions of the processing devices 302.

The mapping device 206 and the computing integrated circuit device 202 may perform an address transform 402 or dynamic mapping to the processing devices 302 without affecting a software code 404 running on the computing integrated circuit device 202. The software code 404 may be from the memory device 204 of FIG. 2. The address transform 402 may be dynamically updated by the control circuit 322 of FIG. 3, the mapping circuit 326 of FIG. 3, or a combination thereof in the mapping device 206.

As an example, the software code 404 may map a first processor address 406 as “0X11XXXXX” for the first processor device 308 and a second processor address 408 as “0X21XXXXX” for the second processor device 310. The address transform 402 may map the first processor address 406 from a software side having the software code 404 to the second processor address 408 for the second processor device 310. The address transform 402 may also map the second processor address 408 from the software side to the first processor address 406 for the first processor device 308.

For illustrative purposes, the address transform 402 is shown swapping the first processor address 406 and the second processor address 408 at the software side to the second processor address 408 and the first processor address 406, respectively, at the hardware side. Although it is understood that the address transform 402 may perform other address mapping other than swapping. For example, the address transform 402 may map more than one processor address to one of the processing devices 302 thereby not utilizing a portion of the processing devices 302. As another example, the address transform 402 may map a single processor address to more than one of the processing devices 302 for benchmarking or parallel processing.

It has been discovered that the present invention improves the lifetime of computing integrated circuits by sharing the load of the processing devices among the available processing devices. The mapping circuit generates dynamic addresses in a predetermined algorithm or a randomizing algorithm thereby mitigating software code bias for particular processing devices in the electronic system. The bias avoidance spreads the activity level among the available processing devices such that the heat generated in the computing integrated circuit device is distributed across the processing devices leading to improved reliability and performance of the computing integrated circuit device.

For example, in near future, one processor, such as the computing integrated circuit device 202, may include tens of cores, such as the processing devices 302, which enables more calculations and more complex calculations. However, if each core is assigned a fixed identification (ID) or address, the cores may encounter with problems with some of cores malfunctions, for example some specific program does not execute. The ID randomizing can minimize the use of the bad cores reducing or eliminating problems in using the processors. For example, if 1 out of 20 cores goes bad, the customer see the problem only 1 out of 20 boots, or 5%.

It may be said that the system should permanently avoid using the bad core once the problem is found. However, it is sometimes difficult to implement the test that detects the problem into the system after going to market.

It has also been discovered that the present invention extends the lifetime of other devices in the electronic assembly system by reducing usage of those devices. For example, randomizing is very important especially for a mobile product which has limited rewritable non-volatile memory or FLASH memory size. If the FLASH memory stores the device configuration after every power off, it may overuse re-write time of FLASH. But the device reconfiguration may be avoided if you randomize the processor or core IDs.

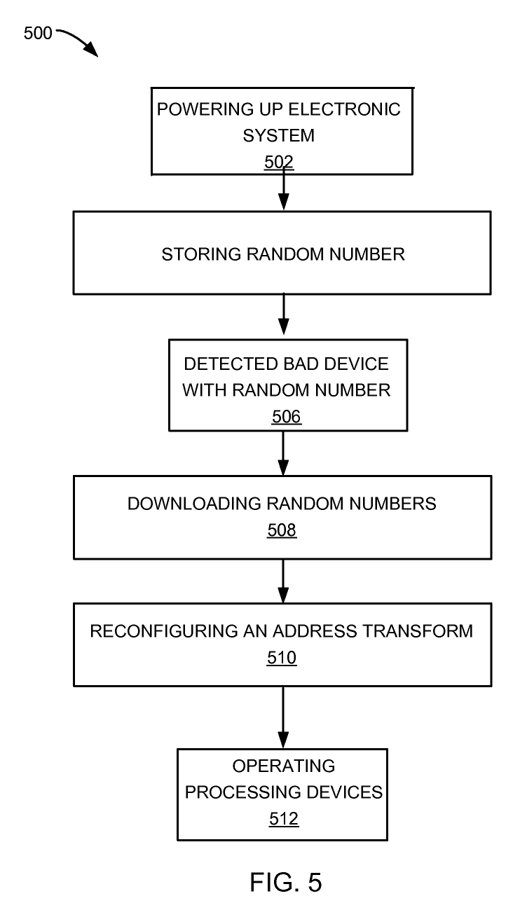

Referring now to FIG. 5, therein is shown a flow chart of a selection process 500 of the electronic assembly system of FIG. 2. The selection process 500 presents one example of the dynamic selection or randomization of address mapping. The selection process 500 includes: powering up the electronic system in a block 502; storing random numbers calculated in the mapping device into a storage circuit in a block 504; detecting one of processing devices selected with one of the random numbers is a bad in a block 506; downloading random numbers with the one selected of the processing devices that is not bad in a block 508; reconfiguring an address transform with the random numbers in a block 510; and operating the processing devices in a block 512.

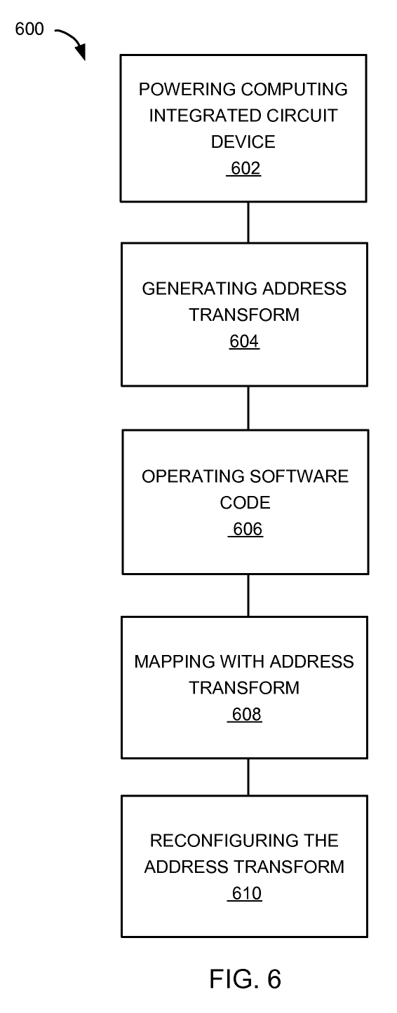

Referring now to FIG. 6, therein is shown a flow chart of an electronic system 600 for operation of the electronic assembly system 200 in an embodiment of the present invention. The system 600 includes powering a computing integrated circuit device having a first processor device and a second processor device in a block 602; generating an address transform for the first processor device and the second processor device in a block 604; operating a software code having a first processor address for the first processor device and a second processor address for the second processor device with the software code provides a display or actuates a mechanic device in a block 606; mapping the first processor address with the address transform to the second processor address in a block 608; and reconfiguring the address transform in a block 610.

Yet other important aspects of the embodiments include that it valuably supports and services the historical trend of reducing costs, simplifying systems, and increasing performance.

These and other valuable aspects of the embodiments consequently further the state of the technology to at least the next level.

Thus, it has been discovered that the electronic system of the present invention furnishes important and heretofore unknown and unavailable solutions, capabilities, and functional aspects for improving reliability in systems. The resulting processes and configurations are straightforward, cost-effective, uncomplicated, highly versatile, and effective, can be implemented by adapting known technologies, and are thus readily suited for efficiently and economically manufacturing stackable integrated circuit package system.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An electronic system comprising:
powering a computing integrated circuit device having a first processor device and a second processor device;
generating an address transform for the first processor device and the second processor device;
operating a software code having a first processor address for the first processor device and a second processor address for the second processor device with the software code provides a display or actuates a mechanic device;
mapping the first processor address with the address transform to the second processor address; and
reconfiguring the address transform.

2. The system as claimed in claim 1 wherein reconfiguring the address transform includes power cycling the computing integrated circuit device.

3. The system as claimed in claim 1 wherein generating the address transform includes not mapping to the second processor device.

4. The system as claimed in claim 1 further comprising mapping the second processor address with the address transform to the first processor device.

5. The system as claimed in claim 1 wherein generating the address transform includes randomly generating the address transform.

6. An electronic system comprising:
powering a mapping device for providing a mapping output;
powering a computing integrated circuit device having a first processor device and a second processor device with the mapping device coupled with the computing integrated circuit device;
generating an address transform based on the mapping output for the first processor device and the second processor device;
operating a software code having a first processor address for the first processor device and a second processor address for the second processor device with the software code provides a display or actuates a mechanic device;
mapping the first processor address with the address transform to the second processor address; and
reconfiguring the address transform.

7. The system as claimed in claim 6 wherein powering the mapping device for providing the mapping output includes operating a control circuit in the mapping device for generating the mapping output.

8. The system as claimed in claim 6 wherein reconfiguring the address transform includes operating the mapping device for providing a further mapping output.

9. The system as claimed in claim 6 wherein reconfiguring the address transform includes operating the mapping device for randomizing the mapping output.

10. The system as claimed in claim 6 wherein powering the mapping device for providing the mapping output includes:
storing the mapping output in the mapping device; and
operating the mapping device for generating a further mapping output based on the stored value of the mapping output.

11. An electronic system comprising:
a computing integrated circuit device having a first processor device and a second processor device;
a mapping circuit for generating an address transform for the first processor device and the second processor device and for reconfiguring the address transform with the mapping circuit coupled to the computing integrated circuit device;
a memory device, having a software code, coupled to the computing integrated circuit device with the software code having a first processor address for the first processor device and a second processor address for the second processor device; and
a selection circuit for mapping the first processor address with the address transform to the second processor address.

12. The system as claimed in claim 11 wherein the mapping circuit includes a control circuit for reconfiguring the address transform.

13. The system as claimed in claim 11 wherein the mapping circuit includes a control circuit for generating the address transform not mapping to the second processor device.

14. The system as claimed in claim 11 wherein the mapping circuit includes a control circuit for generating the address transform mapping to the second processor address to the first processor device.

15. The system as claimed in claim 11 wherein the mapping circuit includes a control circuit for randomly generating the address transform.

16. The system as claimed in claim 11 wherein the mapping circuit is included in a mapping device for generating a mapping output with the address transform based on the mapping output.

17. The system as claimed in claim 16 wherein the mapping device includes a control circuit for generating the mapping output.

18. The system as claimed in claim 16 wherein the mapping device includes a control circuit for generating a further mapping output.

19. The system as claimed in claim 16 wherein the mapping device includes a control circuit for randomizing the mapping output.

20. The system as claimed in claim 16 wherein the mapping device includes:
a storage circuit for storing the mapping output; and
a control unit for generating a further mapping output based on the stored value of the mapping output.
